(19) United States
(12) Patent Application Publication
(10) Pub. No.: US 2023/0045359 A1
(43) Pub. Date: Feb. 9, 2023

(54) INERTIAL MEASUREMENT MODULE, SHOCK ABSORPTION SYSTEM, AND UNMANNED AERIAL VEHICLE

(71) Applicant: AUTEL ROBOTICS CO., LTD., Shenzhen (CN)

(72) Inventor: Han GAO, Shenzhen (CN)

(21) Appl. No.: 17/938,716

(22) Filed: Oct. 7, 2022

Related U.S. Application Data
(63) Continuation of application No. PCT/CN2021/083348, filed on Mar. 26, 2021.

(30) Foreign Application Priority Data
Apr. 8, 2020 (CN) 202010269676.6

(51) Int. Cl. G01C 21/16; G01K 7/16

(52) U.S. Cl. CPC G01C 21/166; G01C 21/165; G01K 7/16

(57) ABSTRACT

Embodiments of the present invention are an inertial measurement module, includes a mount, a circuit board, an inertial measurement assembly, a thermally conductive member and a counterweight assembly. The circuit board is mounted to a surface of the mount. The inertial measurement assembly includes a thermal resistor and an inertial measurement unit. The thermally conductive member is configured to abut against the thermal resistor and the inertial measurement unit. The counterweight assembly is mounted to the surface of the mount. A first groove is arranged on an end surface of the counterweight assembly facing the mount. A receiving space is formed by the first groove and the end surface of the mount. The thermally conductive member and the inertial measurement assembly are both received in the receiving space. The thermally conductive member is arranged at a preset distance from a bottom of the first groove.

### CROSS-REFERENCE TO RELATED APPLICATIONS

The present application is a continuation of International Application No. PCT/CN2021/083348, filed on Mar. 26, 2021, which claims priority to Chinese Patent Application No. 2020102696766, filed on Apr. 8, 2020, which is incorporated herein by reference in its entirety.

### TECHNICAL FIELD

Embodiments of the disclosure relate to the technical field of unmanned aerial vehicles (UAV), and in particular, to an inertial measurement module, a shock absorption system, and a UAV.

### BACKGROUND

An inertial measurement assembly is configured to detect attitude information of a moving object. The inertial measurement assembly generally includes an accelerometer and a gyroscope. The accelerometer is configured to detect an acceleration component of the object, and the gyroscope is configured to detect angle information of the object. By virtue of the function of measuring a three-axis attitude angle (or an angular rate) and an acceleration of an object, an inertial measurement unit is usually used as a core component for navigation and guidance, and is widely used in devices requiring motion control such as vehicles, ships, robots, or aircrafts.

During implementation of the disclosure, the inventor of the disclosure found the following problem: Currently, a thermally conductive material of the inertial measurement assembly of the UAV directly covers surfaces of a thermal resistor and an inertial measurement body, and is held through mating of an upper shell and a lower shell, so that heat generated by the thermal resistor can be transferred to the inertial measurement body, thereby causing the inertial measurement body to be at a normal operation temperature. However, in the assembled structure, squeeze exists between the thermally conductive material and the inertial measurement body. During flight of the UAV, a stress change of the inertial measurement body caused by a temperature change causes inaccuracy and instability of flight control, resulting in inconvenience during use.

### SUMMARY

In order to resolve the foregoing technical problems, embodiments of the disclosure provide an inertial measurement module, a shock absorption system, and an unmanned aerial vehicle (UAV) that are easy to use.

The embodiments of the disclosure adopt the following technical solution to resolve the technical problem.

An inertial measurement module is provided, including:

a mount;

a circuit board, mounted to a surface of the mount;

an inertial measurement assembly, including a thermal resistor and an inertial measurement unit, where the thermal resistor and the inertial measurement unit are spaced apart on the circuit board;

a thermally conductive member, mounted to the circuit board and configured to abut against the thermal resistor and the inertial measurement unit, so that heat generated by the thermal resistor is transferred to the inertial measurement unit; and

a counterweight assembly, mounted to the surface of the mount, where a first groove is arranged on an end surface of the counterweight assembly facing the mount, a receiving space is formed by the first groove and the end surface of the mount, the thermally conductive member and the inertial measurement assembly are both received in the receiving space, and the thermally conductive member is arranged at a preset distance from a bottom of the first groove.

Optionally, an end surface of the thermally conductive member abuts against the thermal resistor. A side surface adjacent to the end surface abuts against a side surface of the inertial measurement unit.

Optionally, the counterweight assembly includes a thermally insulative cover and a counterweight block. One end of the thermally insulative cover mates with and is mounted to an end of the counterweight block. An other end of the thermally insulative cover is mounted to the end surface of the mount. The first groove is arranged on the other end of the thermally insulative cover.

Optionally, a protruding frame is arranged on the surface of the mount. The circuit board is mounted in the protruding frame. An inner wall of the thermally insulative cover abuts against an outer wall of the protruding frame, so that the thermally insulative cover is positioned on and mounted to the mount.

Optionally, a first opening is arranged on the protruding frame. A second opening is arranged on the thermally insulative cover. The first opening and the second opening are respectively configured to communicate an inner space of the protruding frame and the first groove with the outside.

When the thermally insulative cover is mounted to the mount, the first opening and the second opening are located on a same end and are aligned and form a channel, and a connection line of the circuit board extends out through the channel.

Optionally, a protruding block is arranged on an end of the thermally insulative cover. An open groove is arranged on an end of the counterweight block. The protruding block is inserted into the open groove, so that the counterweight block is fixedly mounted to the thermally insulative cover.

The embodiments of the disclosure further adopt the following technical solution to resolve the technical problem:

A shock absorption system is provided, including:

the inertial measurement module described above;

a support, configured to be mounted to a fuselage of a UAV; and

a shock-absorbing connection assembly, configured to be connected to the inertial measurement module and the support.

Optionally, the support includes a hoop and a supporting post, one end of the supporting post is connected with the hoop, and an other end of the supporting post is configured to be connected with the fuselage of the UAV.

Optionally, the hoop is integrally formed with the supporting post.

Optionally, the shock-absorbing connection assembly includes a mounting post and a connecting post. A first through hole is arranged on the hoop. A second through hole is arranged on the mount

The mounting post includes a step portion and a stepped connecting portion. The mounting post is mounted to the hoop. The step portion abuts against the hoop. The stepped connecting portion extends through and is exposed from the first through hole.

A third through hole is arranged on one end of the connecting post. A stepped groove is arranged on an inner wall of the third through hole. The end of the connecting post is connected to one end of the mounting post. The stepped groove is wrapped around the stepped connecting portion. An other end of the connecting post extends through the second through hole, so that the mount is fixedly mounted to the support.

Optionally, the connecting post includes an expandable tube portion, a shock absorption body and an upper neck portion. Two ends of the upper neck portion are respectively connected to one ends of the expandable tube portion and the shock absorption body. A third through hole is arranged on an other end of the expandable tube portion. The stepped groove is arranged on an inner wall of the expandable tube portion. The mounting post is inserted into the expandable tube portion, so that the stepped groove is engaged with the stepped connecting portion.

Optionally, the connecting post further includes a guiding post portion and a lower neck portion. One end of the lower neck portion is connected to an other end of the shock absorption body. An other end of the lower neck portion is connected to one end of the guiding post portion. An other end of the guiding post portion extends through the second through hole. The mount is mounted to the lower neck portion, so that the mount abuts against the other end of the shock absorption body.

The embodiments of the disclosure further adopt the following technical solution to resolve the technical problem.

An UAV is provided, including the above shock absorption system and a fuselage. The shock absorption system is mounted to the fuselage.

The beneficial effects of the embodiments of the disclosure are as follows. The inertial measurement module provided in the embodiments of the disclosure includes the mount, the circuit board, the inertial measurement assembly, the thermally conductive member and the counterweight assembly. The circuit board is mounted to the surface of the mount. The inertial measurement assembly is mounted to the circuit board. The inertial measurement assembly includes the thermal resistor and the inertial measurement unit. The thermal resistor and the inertial measurement unit are mounted to preset mounting positions on the circuit board. The thermally conductive member is mounted to the circuit board, and is configured to abut against the thermal resistor and the inertial measurement unit, so that the heat generated by the thermal resistor is transferred to the inertial measurement unit. The counterweight assembly is mounted to the surface of the mount. The first groove is arranged on the end surface of the counterweight assembly facing the mount. The receiving space is formed by the first groove and the end surface of the mount. The thermally conductive member and the inertial measurement assembly are both received in the receiving space. The thermally conductive member is arranged at the preset distance from the bottom of the first groove. In this way, the counterweight assembly and the thermally conductive member are prevented from contacting each other, and the thermally conductive member and the inertial measurement unit are prevented from squeezing each other. Therefore, the stress change of the inertial measurement unit caused by the temperature change is reduced or prevented, thereby improving the accuracy and stability of flight control and facilitating usage.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic structural diagram of an inertial measurement module according to an embodiment of the disclosure.

FIG. 2 is a structural exploded view of FIG. 1.

FIG. 3 is a schematic structural diagram of a thermally insulative cover in FIG. 2.

FIG. 4 is a cross-sectional view of FIG. 1 from another perspective.

FIG. 5 is a schematic structural diagram of a shock absorption system according to another embodiment of the disclosure.

FIG. 6 is a partial schematic structural diagram of FIG. 5.

FIG. 7 is a structural disassembled view of FIG. 6.

FIG. 8 is a schematic structural diagram of a connecting post in FIG. 7.

FIG. 9 is a cross-sectional view of FIG. 8.

### DETAILED DESCRIPTION

For ease of understanding the disclosure, the disclosure is described in more detail below with reference to the accompanying drawings and specific embodiments. It should be noted that, when a component is expressed as “being fixed to” another component, the component may be directly on the other components, or one or more intermediate components may exist between the component and the other components. When one component is expressed as “being connected to” another component, the component may be directly connected to the other components, or one or more intermediate components may exist between the component and the other components. In the description of this specification, orientation or position relationships indicated by terms such as “up”, “down”, “inside”, “outside”, “vertical”, and “horizontal” are based on orientation or position relationships shown in the accompanying drawings, and are merely used for ease of description of the disclosure and for brevity of description, rather than indicating or implying that the mentioned apparatus or element needs to have a particular orientation or needs to be constructed and operated in a particular orientation, and therefore should not be understood as a limitation on the disclosure. In addition, terms “first” and “second” are merely used for description and should not be understood as indicating or implying relative importance.

Unless otherwise defined, meanings of all technical and scientific terms used in the disclosure are the same as that usually understood by a person skilled in the technical field to which the disclosure belongs. Terms used in the specification of the disclosure are merely intended to describe objectives of the specific embodiment, and are not intended to limit the disclosure. A term “and/or” used in this specification includes any or all combinations of one or more related listed items.

In addition, technical features involved in different embodiments of the disclosure described below may be combined together if there is no conflict.

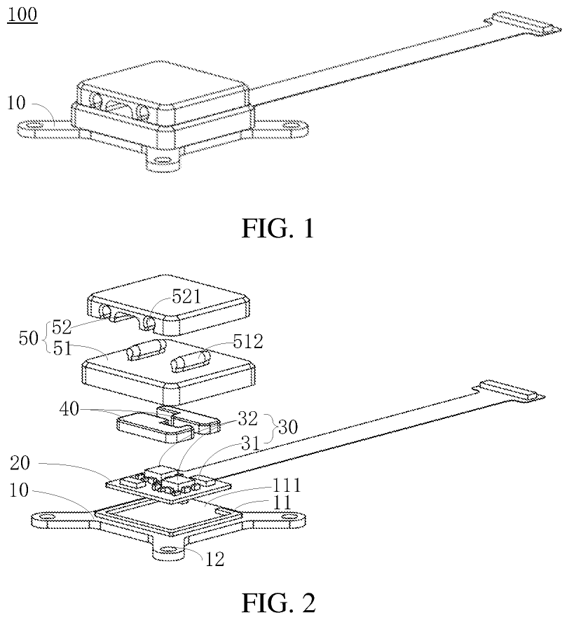

Referring to FIG. 1 to FIG. 3, an inertial measurement module 100 in an embodiment of the disclosure includes a mount 10, a circuit board 20, an inertial measurement assembly 30, a thermally conductive member 40 and a counterweight assembly 50. The circuit board 20 is mounted to a surface of the mount 10. The inertial measurement assembly 30 and the thermally conductive member 40 are mounted to the circuit board 20. The counterweight assembly 50 is mounted to the mount 10. A first groove 511 is arranged on an end surface of the counterweight assembly 50 facing the mount 10. A receiving space is formed by the first groove 511 and the end surface of the mount 10. The inertial measurement assembly 30 includes a thermal resistor 31 and an inertial measurement unit 32. The thermal resistor 31 and the inertial measurement unit 32 are mounted to preset mounting positions on the circuit board 20. The thermally conductive member 40 is configured to abut against the thermal resistor 31 and the inertial measurement unit 32, so that heat generated by the thermal resistor 31 is transferred to the inertial measurement unit 32. The thermally conductive member 40 and the inertial measurement assembly 30 are both received in the receiving space. The thermally conductive member 40 is arranged at a preset distance from a bottom of the first groove 511.

A protruding frame 11 is arranged on the surface of the mount 10. The protruding frame 11 is formed by stretching, from the surface of the mount 10 by a certain distance, a structure resembling a Chinese character “ [symbol] ” which is formed by two closed squares, with each side of one of the two squares spaced from a corresponding side of the other of the two squares by a fixed distance. The protruding frame 11 is configured to position and mount the circuit board 20. It may be understood that a thickness of the protruding frame 11 is greater than or equal to a thickness of the circuit board 20, so that the circuit board 20 can be completely received within the protruding frame 11. Further, a first opening 111 is arranged on a side wall of the protruding frame 11. The first opening 111 is configured to communicate an inner space of the protruding frame 11 with the outside.

In some embodiments, a second through hole 12 configured to connect and assemble other parts of an unmanned aerial vehicle (UAV) is arranged on each of four corners of the mount 10.

The circuit board 20 is detachably mounted to the mount 10. Specifically, the circuit board 20 is mounted to the protruding frame 11, and a connection line of the circuit board 20 may extend out through the first opening 111, so that the circuit board 20 can be connected to the outside.

In addition to the thermal resistor 31 and the inertial measurement unit 32 described above, the inertial measurement assembly 30 further includes other elements such as a capacitor. The elements are mounted to the circuit board, and jointly realize measurement of a three-axis attitude angle and an acceleration during movement of the UAV.

The thermally conductive member 40 is mounted to the circuit board 20. The thermally conductive member 40 is respectively in contact with the thermal resistor 31 and the inertial measurement unit 32, so that the heat can be transferred to the inertial measurement unit 32 during operation of the thermal resistor. It may be understood that the thermally conductive member 40 may be arranged on the circuit board 20 in two manners. In a first manner, the thermally conductive member 40 directly covers a same end surface of the thermal resistor 31 and the inertial measurement unit 32. In a second manner, an end surface of the thermally conductive member 40 abuts against the thermal resistor 31, and a side surface adjacent to the end surface abuts against a side surface of the inertial measurement unit 32. In this embodiment, the thermally conductive member 40 is arranged in the second manner. The inertial measurement unit 32 and the thermally conductive member 40 do not act on each other, which reduces the stress change of the inertial measurement unit 32 caused by the temperature change.

The counterweight assembly 50 includes a thermally insulative cover 51 and a counterweight block 52. One end of the thermally insulative cover 51 mates with and is mounted to an end of the counterweight block 52. An other end of the thermally insulative cover 51 is mounted to the end surface of the mount.

An end surface of the thermally insulative cover 51 protrudes outward and forms a protruding block 512, and the first groove 511 is arranged on an other end surface. A mold cavity 5111 and an avoidance groove 5112 are arranged on the bottom of the first groove 511. A second opening 5113 is arranged on a side wall of the first groove 511. An external dimension of the mold cavity 5111 matches an external dimension of the thermally conductive member 40, so that the thermally conductive member 40 can be received in the mold cavity 5111 when the thermally insulative cover 51 is mounted to the mount 10. Likewise, the avoidance groove 5112 is configured to receive the inertial measurement unit 32. The second opening 5113 is configured to communicate an inner space of the first groove 511 with the outside. In addition, the second opening 5113 and the first opening 111 are located on a same side and aligned to form a channel, so that the connection line of the circuit board 20 can extend out through the channel for connection to the outside.

Specifically, during use, an inner wall of the thermally insulative cover 51 abuts against an outer wall of the protruding frame 11 when the thermally insulative cover 51 is mounted to the mount 10, so that the thermally insulative cover is arranged above the circuit board 20. It may be understood that, if the heat generated by the thermal resistor 31 is dissipated quickly, a heating time of the inertial measurement unit 32 before take-off of the UAV is prolonged. In order prevent the problem, the thermally insulative cover 51 is made of a material having a relatively small thermal conductivity, such as plastic, so as to increase the difficulty of the heat transfer in the receiving space. In this way, the heating time of the inertial measurement unit 32 before take-off the UAV is reduced.

An open groove 521 is arranged on an end surface of the counterweight block 52. The open groove 521 is configured to mate with and be mounted to the protruding block 512, so that the counterweight block 52 is detachably mounted to the thermally insulative cover 51. It may be understood that, in addition to the above fixing manner, the counterweight block 52 may alternatively be detachably mounted to the thermally insulative cover 51 through a screw or through a snap. In this embodiment, the open groove 521 is in interference fit with the protruding block 512. Certainly, in order to facilitate disassembly and assembly, the protruding block 512 is made of an elastic material, such as rubber.

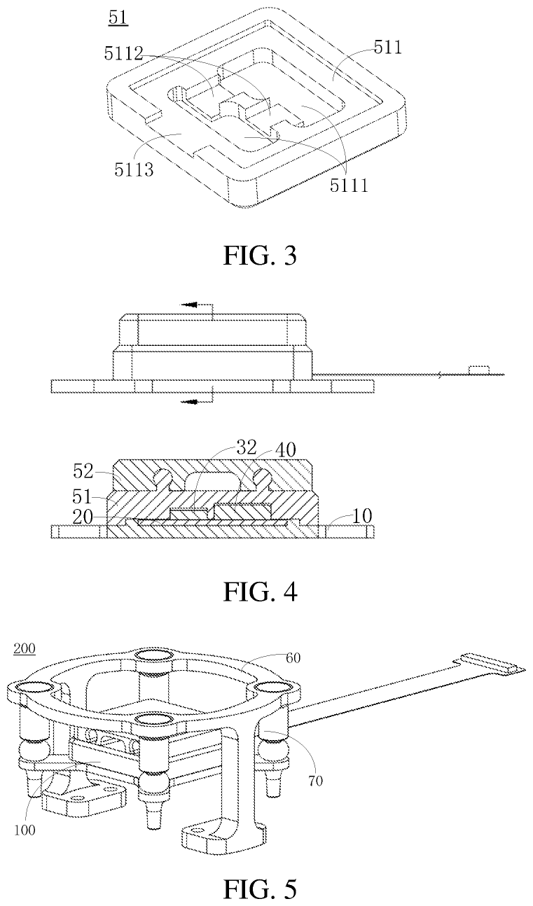

Referring to FIG. 3 and FIG. 4, during assembly and use, the thermally insulative cover 51 is mounted to the mount 10, the bottom of the first groove 511 is arranged at a preset distance to the thermally conductive member 40, and the thermally conductive member 40 and the thermally insulative cover 51 do not contact each other, that is, do not squeeze each other. During the flight of the UAV, the inertial measurement unit 32, the thermally insulative cover 51 and the thermally conductive member 40 are free of the stress change caused by the temperature change, which improves the accuracy and stability of the flight of the UAV and facilitating usage.

During the flight of the UAV, a fuselage of the UAV is shocked to some extent, which affects the normal operation of the inertial measurement module 100. In order to reduce the impact of the shock of the fuselage of the UAV on the inertial measurement module 100, another embodiment of the disclosure provides a shock absorption system 200, as shown in FIG. 5. The shock absorption system includes the inertial measurement module 100 in the above embodiment, a support 60 and a shock-absorbing connection assembly 70. The support 60 is configured be mounted to the fuselage of the UAV. The shock-absorbing connection assembly 70 is configured to be connected to the inertial measurement module 100 and the support 60.

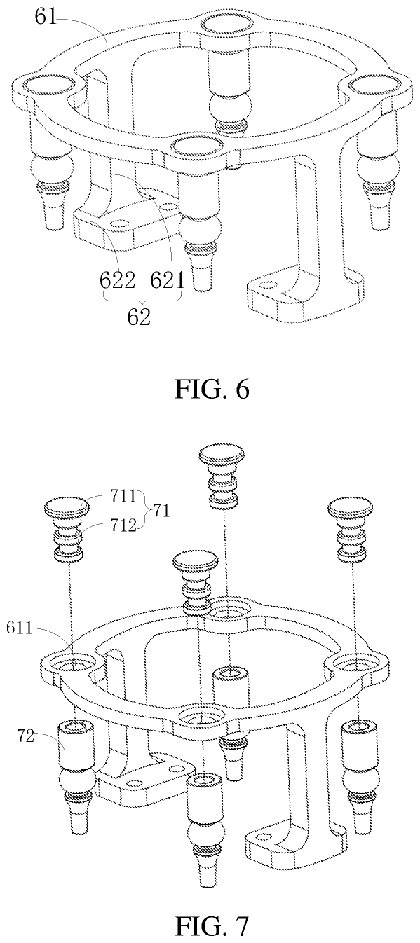

Referring to FIG. 6 and FIG. 7, the support 60 includes a hoop 61 and a supporting post 62. One end of the supporting post 62 is connected to the hoop 61, and an other end of the supporting post 62 is configured to be connected to the fuselage of the UAV. A first through hole 611 is arranged on the hoop 61. The first through hole 611 is configured to mount the shock-absorbing connection assembly 70. It may be understood that the hoop 61 may be circular, or may be square, oval, or the like, as long as the shock-absorbing connection assembly 70 can fixedly mount the inertial measurement module 100 to the support 60. In this embodiment, the hoop 61 is circular, and the first through hole 611 is a countersunk hole.

The supporting post 62 includes a supporting portion 621 and a base portion 622. One end of the supporting portion 621 is connected to the hoop 61, and an other end is connected to the base portion 622. The base portion 622 is provided with a through hole (not shown). The support 60 may be fixedly mounted to the fuselage of the UAV through the through hole. Alternatively, the support 60 may be fixed to the fuselage of the UAV by bonding or snapping.

In some embodiments, the hoop 61 is integrally formed with the supporting post 62.

The shock-absorbing connection assembly 70 includes a mounting post 71 and a connecting post 72. One end of the mounting post 71 extends through the first through hole 611 and is connected to one end of the connecting post 72, and an other end of the connecting post 72 is connected to the mount 10, so that the mount 10 can be hung on the support 60.

The mounting post 71 includes a step portion 711 and a stepped connecting portion 712. The step portion 711 is configured to mate with and be mounted to the hoop 61. The stepped connecting portion 712 is configured to be connected to the connecting post 72. Specifically, during mounting, the stepped connecting portion 712 extends through and is exposed from the first through hole 611, and the step portion 711 abuts against the hoop 61. It may be understood that the step portion 711 may be received in the countersunk hole when the first through hole 611 is a countersunk hole.

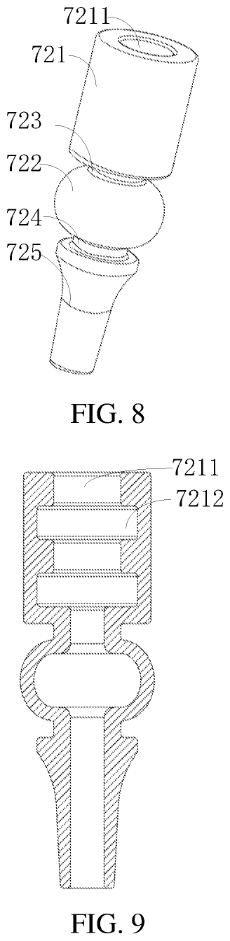

Referring to FIG. 8 and FIG. 9, the connecting post 72 includes an expandable tube portion 721, a shock absorption body 722 and an upper neck portion 723. Two ends of the upper neck portion 723 are respectively connected to one ends of the expandable tube portion 721 and the shock absorption body 722. An other end of the expandable tube portion 721 is connected to the mounting post 71. Specifically, a third through hole 7211 and a stepped groove 7212 are arranged on the other end of the expandable tube portion 721. The stepped groove 7212 is located on a hole wall of the third through hole 7211. An external shape of the stepped groove 7212 matches an external shape of the stepped connecting portion 712. It may be understood that the stepped connecting portion 712 may be inserted into the expandable tube portion 721, and the stepped connecting portion 712 may be engaged with the stepped groove 7212, so that the mounting post 71 is connected to the connecting post 72. In this embodiment, a diameter of the third through hole 7211 is slightly less than a diameter of the stepped connecting portion 712, that is to say, the stepped connecting portion 712 is in interference fit with the stepped groove 7212. Meanwhile, in order to facilitate assembly and disassembly, one of the stepped connecting portion 712 and the expandable tube portion 721 is made of an elastic material such as rubber.

Further, the connecting post 72 further includes a lower neck portion 724 and a guiding post portion 725. One end of the lower neck portion 724 is connected to an other end of the shock absorption body 722. An other end of the lower neck portion 724 is connected to one end of the guiding post portion 725. Specifically, during mounting and use, an other end of the guiding post portion 725 extends through the second through hole 12, and the mount 10 is engaged with the lower neck portion 724, so that the mount 10 abuts against the other end of the shock absorption body 722. In this embodiment, the shock absorption body 722, the upper neck portion 723, the lower neck portion 724 and the guiding post portion 725 are all made of elastic materials. One end of the guiding post portion 725 close to the lower neck portion 724 extends outward and forms a rounded corner, and an outer diameter of an other end is required to be less than that of the second through hole 12, to facilitate mounting of the connecting post 72 and the mount 10.

In some embodiments, the lower neck portion 724 of the connecting post 72 is engaged with the first through hole 611 of the support 60, and the stepped connecting portion 712 of the mounting post 71 extends through the second through hole 12 and is connected to the expandable tube portion 721, so that the mount 10 is mounted to the support 60.

It may be understood that, during the flight of the UAV, the fuselage is shocked to some extent, and the support 60 mounted to the fuselage of the UAV is shocked accordingly. Therefore, the mount 10 is shocked and squeezes the shock absorption body 722. The shock absorption body 722 compresses the upper neck portion 723 or the lower neck portion 724 under the action of the external force, so that the upper neck portion 723 or the lower neck portion 724 is elastically deformed. Restoration of the upper neck portion or the lower neck portion from the elastic deformation generates a reaction force to the shock of the mount 10, which realizes a shock absorption effect, thereby ensuring the normal operation of the inertial measurement assembly 30.

Another embodiment of the disclosure provides a UAV (not shown), including the above shock absorption system 200 and a fuselage (not shown). The shock absorption system 200 is mounted to the fuselage.

The above descriptions are merely the implementations of the disclosure, and are not intended to limit the scope of the disclosure. Any equivalent structure or equivalent process transformation made by using the contents of the description and the drawings of the disclosure or direct or indirect application to other related technical fields are encompassed in the protection scope of the disclosure.

What is claimed is:

1. An inertial measurement module, comprising:
a mount;
a circuit board, mounted to a surface of the mount;
an inertial measurement assembly, comprising a thermal resistor and an inertial measurement unit, wherein the thermal resistor and the inertial measurement unit are spaced apart on the circuit board;
a thermally conductive member, mounted to the circuit board and configured to abut against the thermal resistor and the inertial measurement unit, so that heat generated by the thermal resistor is transferred to the inertial measurement unit; and
a counterweight assembly, mounted to the surface of the mount, wherein a first groove is arranged on an end surface of the counterweight assembly facing the mount, a receiving space is formed by the first groove and the end surface of the mount, the thermally conductive member and the inertial measurement assembly are both received in the receiving space, and the thermally conductive member is arranged at a preset distance from a bottom of the first groove.

2. The inertial measurement module according to claim 1, wherein an end surface of the thermally conductive member abuts against the thermal resistor, and a side surface adjacent to the end surface abuts against a side surface of the inertial measurement unit.

3. The inertial measurement module according to claim 1, wherein the counterweight assembly comprises a thermally insulative cover and a counterweight block, one end of the thermally insulative cover mates with and is mounted to an end of the counterweight block, an other end of the thermally insulative cover is mounted to the end surface of the mount, and the first groove is arranged on the other end of the thermally insulative cover.

4. The inertial measurement module according to claim 3, wherein a protruding frame is arranged on the surface of the mount, the circuit board is mounted in the protruding frame, and an inner wall of the thermally insulative cover abuts against an outer wall of the protruding frame, so that the thermally insulative cover is positioned on and mounted to the mount.

5. The inertial measurement module according to claim 4, wherein a first opening is arranged on the protruding frame, a second opening is arranged on the thermally insulative cover, and the first opening and the second opening are respectively configured to communicate an inner space of the protruding frame and the first groove with the outside; and
when the thermally insulative cover is mounted to the mount, the first opening and the second opening are located on a same end and are aligned and form a channel, and a connection line of the circuit board extends out through the channel.

6. The inertial measurement module according to claim 5, wherein a protruding block is arranged on an end of the thermally insulative cover, an open groove is arranged on an end of the counterweight block, and the protruding block is inserted into the open groove, so that the counterweight block is fixedly mounted to the thermally insulative cover.

7. A shock absorption system, comprising:
an inertial measurement module;
a support, configured to be mounted to a fuselage of an unmanned aerial vehicle (UAV); and
a shock-absorbing connection assembly, configured to be connected to the inertial measurement module and the support, wherein
the inertial measurement module comprises:
a mount;
a circuit board, mounted to a surface of the mount;
an inertial measurement assembly, comprising a thermal resistor and an inertial measurement unit, wherein the thermal resistor and the inertial measurement unit are spaced apart on the circuit board;
a thermally conductive member, mounted to the circuit board and configured to abut against the thermal resistor and the inertial measurement unit, so that heat generated by the thermal resistor is transferred to the inertial measurement unit; and
a counterweight assembly, mounted to the surface of the mount, wherein a first groove is arranged on an end surface of the counterweight assembly facing the mount, a receiving space is formed by the first groove and the end surface of the mount, the thermally conductive member and the inertial measurement assembly are both received in the receiving space, and the thermally conductive member is arranged at a preset distance from a bottom of the first groove.

8. The shock absorption system according to claim 7, wherein the support comprises a hoop and a supporting post, one end of the supporting post is connected with the hoop, and an other end of the supporting post is configured to be connected with the fuselage of the UAV.

9. The shock absorption system according to claim 8, wherein the hoop is integrally formed with the supporting post.

10. The shock absorption system according to claim 8, wherein the shock-absorbing connection assembly comprises a mounting post and a connecting post, a first through hole is arranged on the hoop, and a second through hole is arranged on the mount;
the mounting post comprises a step portion and a stepped connecting portion, the mounting post is mounted to the hoop, the step portion abuts against the hoop, and the stepped connecting portion extends through and is exposed from the first through hole; and
a third through hole is arranged on one end of the connecting post, a stepped groove is arranged on an inner wall of the third through hole, the end of the connecting post is connected to one end of the mounting post, the stepped groove is wrapped around the stepped connecting portion, and an other end of the connecting post extends through the second through hole, so that the mount is fixedly mounted to the support.

11. The shock absorption system according to claim 10, wherein the connecting post comprises an expandable tube portion, a shock absorption body and an upper neck portion, two ends of the upper neck portion are respectively connected to one ends of the expandable tube portion and the shock absorption body, a third through hole is arranged on an other end of the expandable tube portion, the stepped groove is arranged on an inner wall of the expandable tube portion, and the mounting post is inserted into the expandable tube portion, so that the stepped groove is engaged with the stepped connecting portion.

12. The shock absorption system according to claim 11, wherein the connecting post further comprises a guiding post portion and a lower neck portion, one end of the lower neck portion is connected to an other end of the shock absorption body, and an other end of the lower neck portion is connected to one end of the guiding post portion, an other end of the guiding post portion extends through the second through hole, and the mount is engaged with the lower neck portion, so that the mount abuts against the other end of the shock absorption body.

13. An unmanned aerial vehicle (UAV), comprising a shock absorption system and a fuselage, wherein the shock absorption system is mounted to the fuselage; and
the shock absorption system comprises:
an inertial measurement module;
a support, configured to be mounted to a fuselage of a UAV; and
a shock-absorbing connection assembly, configured to be connected to the inertial measurement module and the support, wherein
the inertial measurement module comprises:
a mount;
a circuit board, mounted to a surface of the mount;
an inertial measurement assembly, comprising a thermal resistor and an inertial measurement unit, wherein the thermal resistor and the inertial measurement unit are spaced apart on the circuit board;
a thermally conductive member, mounted to the circuit board and configured to abut against the thermal resistor and the inertial measurement unit, so that heat generated by the thermal resistor is transferred to the inertial measurement unit; and
a counterweight assembly, mounted to a surface of the mount, wherein a first groove is arranged on an end surface of the counterweight assembly facing the mount, a receiving space is formed by the first groove and the end surface of the mount, the thermally conductive member and the inertial measurement assembly are both received in the receiving space, and the thermally conductive member is arranged at a preset distance from a bottom of the first groove.

14. The UAV according to claim 13, wherein the support comprises a hoop and a supporting post, one end of the supporting post is connected with the hoop, and an other end of the supporting post is configured to be connected with the fuselage of the UAV.

15. The UAV according to claim 14, wherein the hoop is integrally formed with the supporting post.

16. The UAV according to claim 14, wherein the shock-absorbing connection assembly comprises a mounting post and a connecting post, a first through hole is arranged on the hoop, and a second through hole is arranged on the mount;
the mounting post comprises a step portion and a stepped connecting portion, the mounting post is mounted to the hoop, the step portion abuts against the hoop, and the stepped connecting portion extends through and is exposed from the first through hole; and
a third through hole is arranged on one end of the connecting post, a stepped groove is arranged on an inner wall of the third through hole, the end of the connecting post is connected to one end of the mounting post, the stepped groove is wrapped around the stepped connecting portion, and an other end of the connecting post extends through the second through hole, so that the mount is fixedly mounted to the support.

17. The UAV according to claim 16, wherein the connecting post comprises an expandable tube portion, a shock absorption body and an upper neck portion, two ends of the upper neck portion are respectively connected to one ends of the expandable tube portion and the shock absorption body, a third through hole is arranged on an other end of the expandable tube portion, the stepped groove is arranged on an inner wall of the expandable tube portion, and the mounting post is inserted into the expandable tube portion, so that the stepped groove is engaged with the stepped connecting portion.

18. The UAV according to claim 17, wherein the connecting post further comprises a guiding post portion and a lower neck portion, one end of the lower neck portion is connected to an other end of the shock absorption body, and an other end of the lower neck portion is connected to one end of the guiding post portion, an other end of the guiding post portion extends through the second through hole, and the mount is engaged with the lower neck portion, so that the mount abuts against the other end of the shock absorption body.
